(19) United States
(12) Patent Application Publication
(10) Pub. No.: US 2008/0023243 A1
(43) Pub. Date: Jan. 31, 2008

(54) FAUX TIRE FOR A JUVENILE RIDE-ON VEHICLE

(75) Inventors: Charles H. Keegan, Milton, MA (US); William A. Henderson, Northborough, MA (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 11/460,578

(22) Filed: Jul. 27, 2006

(51) Int. Cl. B62D 61/06

(52) U.S. Cl. 180/210

(57) ABSTRACT

The present disclosure relates to juvenile ride-on vehicles. More particularly, the present disclosure relates to a motorcycle including a frame, a front wheel, and two rear wheels mounted to the frame.

### BACKGROUND

The present disclosure relates to juvenile ride-on vehicles. More particularly, the present disclosure relates to a motorcycle including a frame, and a front wheel and two rear wheels mounted to the frame.

### SUMMARY

In accordance with the present disclosure, a juvenile ride-on vehicle, such as a motorcycle, includes a frame, a front wheel having an axle mounted to the frame and two faux rear wheels mounted to the frame for rotation about an axis of rotation. The present disclosure further relates to a faux rear wheel including two faux rear rims and a faux tire mounted to the frame, the faux tire enveloping the two faux rear rims such that the faux tire provides a visual appearance to an observer of a single large rear tire included on the juvenile ride-on vehicle.

In illustrative embodiments, the juvenile ride-on vehicle includes a faux tire mounted in a stationary position on the frame. The faux tire includes a tread laterally extending between and over a portion of the faux rear rims and having side walls extending from the tread, the side walls being arranged in close proximity to and partially extending over the faux rear rims such that the faux tire provides a visual appearance to an observer of a single large rear tire mounted on the juvenile ride-on vehicle.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a juvenile ride-on vehicle, according to the present disclosure, including a frame, a front wheel mounted to the frame, and a seat mounted to the frame, and extending rearwardly from the seat is a fender, and lying under the fender is a faux tire mounted to be stationary relative to the seat and the frame, the faux tire providing an interior region receiving substantial portions of first and second faux rear rims that are each mounted to rotate about an axis of rotation relative to the stationary faux tire, the faux tire further providing a visual appearance to an observer of a single large rear tire mounted on the juvenile ride-on vehicle;

FIG. 2 is a side elevation view of the juvenile ride-on vehicle of FIG. 1;

FIG. 3 is an exploded perspective view of the juvenile ride-on vehicle of FIG. 1 showing a fender extending rearwardly from the seat and overlying a battery mounted in a battery receiver formed as a cavity in an upper faux tire section of the faux tire, the upper faux tire section being mounted to the frame via fasteners through openings in a bottom portion of the battery receiver cavity, and further showing a lower faux tire section coupled to the upper faux tire section via faux tire section supports, the upper faux tire section, the faux tire section supports and the lower faux tire section cooperate to form the faux tire having an interior region, the faux tire being configured to be mounted in a stationary position on the frame behind the seat and having openings to allow the faux rear rims, each including a rear wheel and a tire in the form of a wheel band mounted thereon, to contact a riding surface and to rotate about the axis of rotation relative to the faux tire and substantially within the interior region, as suggested in FIG. 1;

FIG. 4 is an enlarged perspective view, with portions broken away, of a rear portion of the juvenile ride-on vehicle of FIG. 1 showing the upper and lower faux tire sections coupled together by faux tire section supports and forming the faux tire mounted on the frame, and a fender overlying a portion of the faux tire, and further showing the faux rear rims mounted to rotate about the axis of rotation within the interior region of the faux tire formed by a tread and side walls of the faux tire;

FIG. 5 is an enlarged bottom perspective view of a rear portion of the juvenile ride-on wheeled vehicle of FIG. 1 showing a bottom portion of a lower faux tire section of the faux tire having lower tread sections and lower side wall sections partially enveloping the two faux rear rims, the lower faux tire section having cutouts configured to accommodate frame members and openings configured to allow the two faux rear rims to contact a riding surface (see FIGS. 1 and 2) and rotate about the axis of rotation, and further showing the lower faux tire section coupled to the section supports (see FIGS. 4, 6 and 7), as suggested by the fasteners positioned on the bottom portion of the lower faux tire section and located adjacent each of the faux rear wheels;

FIG. 6 is a substantially horizontal section view, with a portion broken away, taken through a rear portion of the vehicle along the line 6-6 in FIG. 1, and showing the faux tire including an upper faux tire section having a battery receiver cavity formed therein, a lower faux tire section coupled to the top faux tire section via section supports, a fender extending rearward from the seat and overlying the battery receiver cavity, the upper and lower faux tire sections and the fender having cutouts configured to accommodate frame members, and also showing a battery (depicted in phantom by dotted lines) housed in the cavity and a transmission (depicted in phantom by dotted lines) located in the interior region formed between the upper and lower faux tire sections, and further showing the upper faux tire section having an arc length of 180° and the lower faux tire section having forward and rearward portions having arc lengths of 33° each, thereby providing the observer (shown viewing from the rear of the vehicle) with a visual appearance of a single large rear tire mounted on the juvenile ride-on vehicle;

FIG. 7 is a section view, with a portion broken away, taken along line 7-7 in FIG. 6 and showing the lower faux tire section coupled to the section supports, the upper faux tire section and fender coupled together by fasteners, frame members coupled to a plate located in the interior region, and the battery (depicted in phantom by dotted lines) located in the battery receiver cavity, and further showing the faux rear rims having a wheel, a tire in the form of a wheel band mounted on the wheel, and a wheel cover, the faux rear rims being at least partially enveloped by an upper tread section and side walls of the upper faux tire section and mounted to rotate about the axis of rotation within the interior region of the faux tire when the wheel bands are in contact with the riding surface.

### DETAILED DESCRIPTION

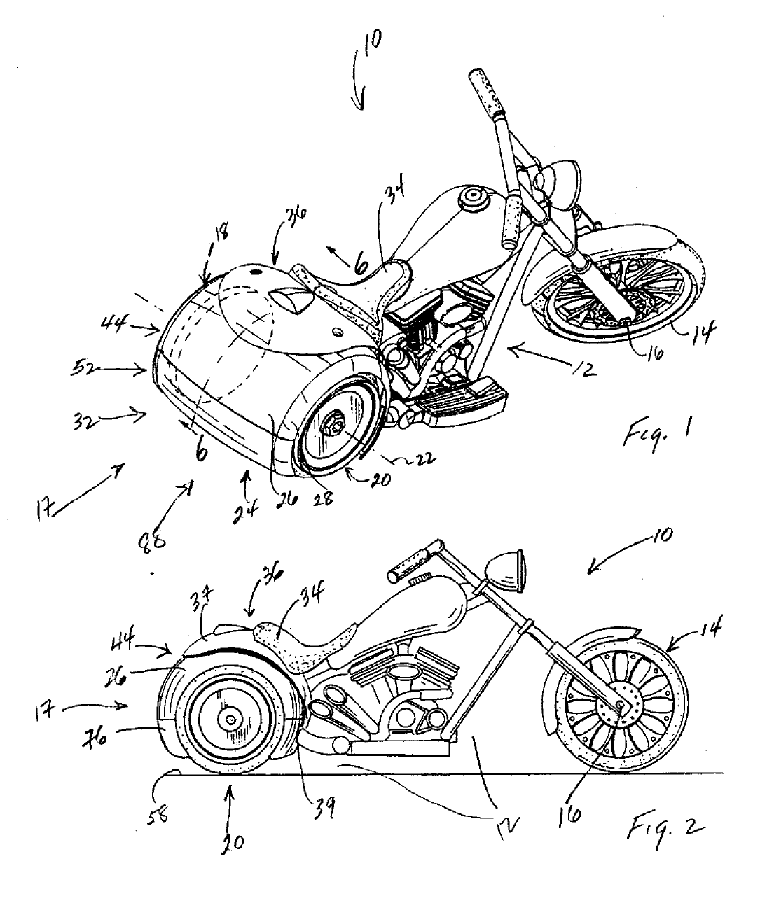

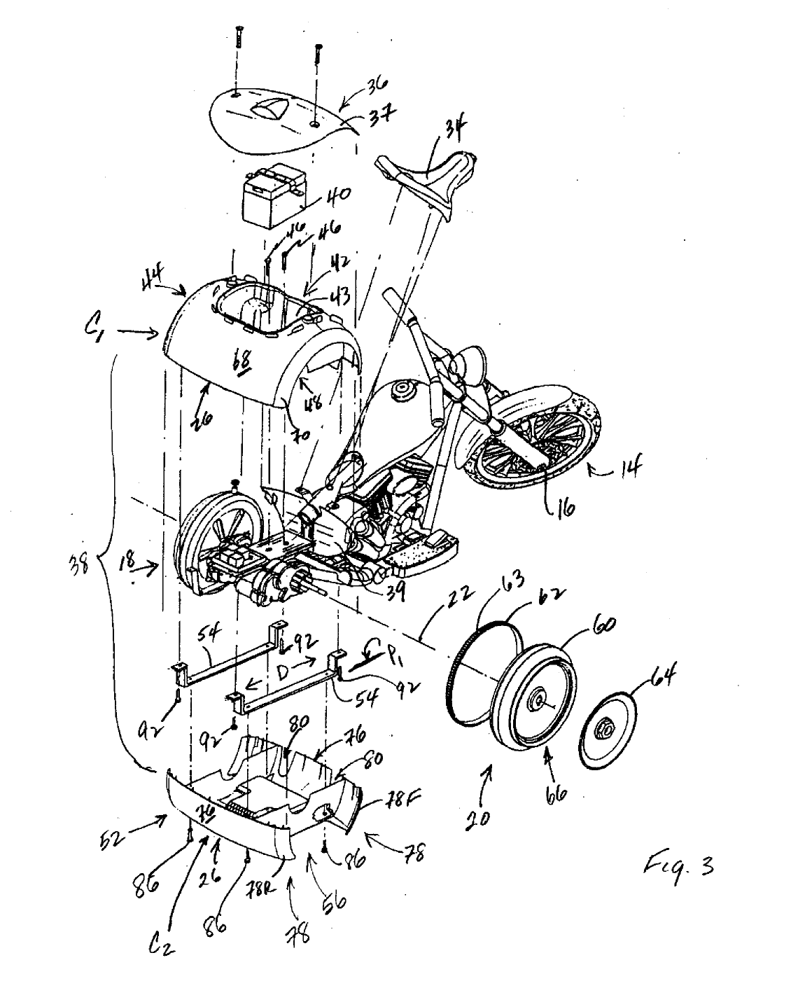

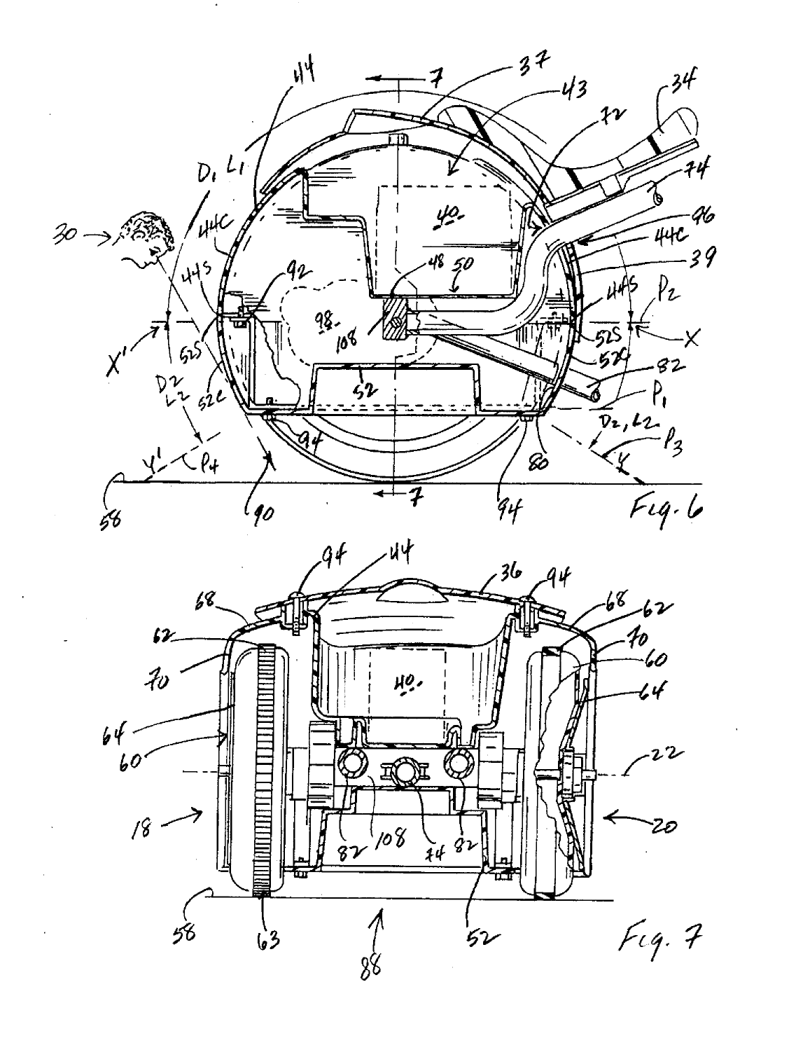

A juvenile ride-on vehicle 10, such as a motorcycle, comprises a frame 12 and a front wheel 14 having an axle 16 mounted to the frame 12. Juvenile ride-on vehicle 10 further comprises a faux rear wheel 17 including first and second faux rear rims 18, 20, respectively, mounted to the frame 12 for rotation about an axis of rotation 22, as shown, for example, in FIGS. 1 and 2. Faux rear wheel 17 also comprises a faux tire 24 mounted in a stationary position on the frame 12. Faux tire 24 includes a tread 26 laterally extending between and over a portion of the faux rear rims 18, 20 and also includes side walls 28 extending from the tread 26, as shown, for example, in FIG. 1. The side walls 28 are arranged in close proximity to and partially extend over the faux rear rims 18, 20 such that the faux tire 24 provides a visual appearance, to an observer 30, of a single large rear tire 32 included on the juvenile ride-on vehicle 10, as shown in FIG. 1 and suggested in FIG. 6.

Juvenile ride-on vehicle 10 further comprises a seat 34 mounted to the frame 12. Extending rearwardly from the seat 34 is a fender 36 and lying under the fender 36 is the faux tire 24 mounted to be stationary relative to the seat 34 and the frame 12. Faux tire 24 provides an interior region 38 for receiving substantial portions of the first and second faux rear rims 18, 20, as suggested in FIGS. 1, 4, and 6.

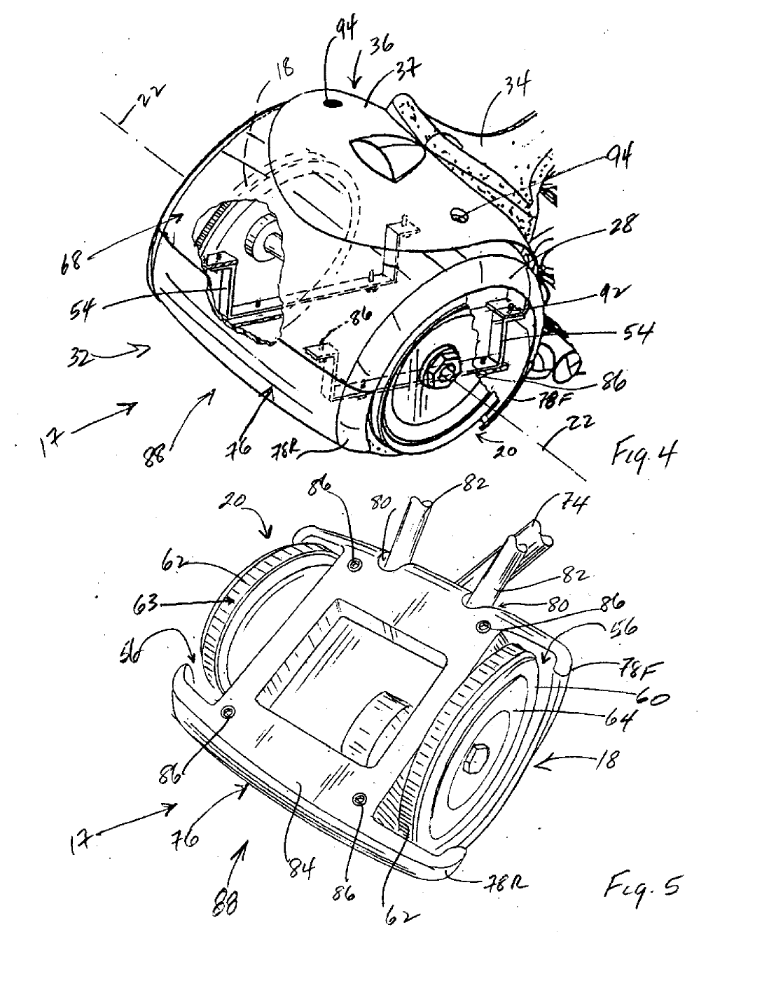

As suggested in FIG. 3, juvenile ride-on vehicle 10 includes front wheel 14 mounted to frame 12 via axle 16. Juvenile ride-on vehicle 10 further includes fender 36 having an upper portion 37 and a lower portion 39, the upper portion 37 extending rearwardly from seat 34 mounted on frame 12 and the lower portion 39 extending forwardly and downwardly from seat 34. Fender 36 overlies a battery 40 mounted in a battery receiver 42 formed as a cavity in an upper faux tire section 44 of faux tire 24, the cavity 42 having an upwardly-facing opening 43. Upper faux tire section 44 is mounted to frame 12 via fasteners 46 through openings 48 in a bottom portion 50 of cavity 42. Faux tire 24 also includes a lower faux tire section 52 coupled to upper faux tire section 44 via faux tire section supports 54. Upper and lower faux tire sections 44, 52, when coupled together, meet at respective mating surfaces 44S, 52S on their respective outer circumferences 44C, 52C, such that they mate in an essentially seamless manner, as suggested in FIG. 6. Upper faux tire section 44, faux tire section supports 54 and lower faux tire section 52 cooperate to form faux tire 24 having interior region 38, as suggested in FIG. 4. Faux tire 24 is configured to be mounted in a stationary position on frame 12 behind seat 34, as suggested in FIGS. 1, 3, 4, and 6. Faux tire 24 includes openings 56 to allow faux rear rims 18, 20 to contact a riding surface 58 and rotate about axis of rotation 22 relative to faux tire 24 and substantially within interior region 38, as suggested in FIGS. 1, 4, 5, and 6.

Faux rear rims 18, 20 each include a wheel 60, a tire 62 in the form of a wheel band having a treaded surface 63 and concentrically overlying and surrounding wheel 60, and a wheel cover 64 coupled to wheel 60 on an exterior side 66 of each faux rear rim 18, 20, as suggested in FIGS. 1, 3, and 4.

As suggested in FIGS. 3-6, upper faux tire section 44 includes upper tread section 68 of tread 26, upper side wall section 70 of side walls 28, and cutout 72 configured to accommodate upper frame member 74. Lower faux tire section 52 includes lower tread section 76, lower side wall section 78 having lower rearward and lower forward sections 78R, 78F, respectively, and cutouts 80 configured to accommodate lower frame members 82. Upper side wall section 70 is continuous along an outer circumference C₁ of upper tread section 68 and lower rearward and lower forward sections 78R, 78F of the lower side wall section 78 are discontinuous along outer circumference C₂ of lower tread section 76. Lower faux tire section 52 further includes a bottom portion 84 having lower tread sections 76 and lower side wall sections 78 partially enveloping faux rear rims 18, 20, as suggested in FIGS. 1 and 4-6. As suggested in FIGS. 4-7, bottom portion 84 is coupled to faux tire section supports 54 via fasteners 86 shown positioned in FIG. 5, for example, adjacent faux rear rims 18, 20. Bottom portion 84 includes openings 48 to allow wheel bands 62 of faux rear rims 18, 20 to contact riding surface 58. Faux rear rims 18, 20 are shown, for example, in FIG. 5 as being partially enveloped by lower tread sections 76 and lower side wall sections 70 of faux tire 24.

An observer 30 is shown, for example, viewing a rear portion 88 of ride-on vehicle 10, as represented by arrow 90. An additional view of rear portion 88 is shown in FIG. 7. As suggested in both FIGS. 6 and 7, lower faux tire section 52 is coupled to faux tire section supports 54 via fasteners 86 and upper faux tire section 44 is coupled to faux tire section supports 54 via fasteners 92. Section supports 54 are configured to extend in a direction D_{S} essentially transverse to axis of rotation 22. Section supports 54 are configured to lie within interior region 38 in a plane P₁ parallel to each other and essentially parallel to riding surface 58. Fender 36 is coupled to upper faux tire section 44 via fasteners 94 (see FIG. 7) and fender 36 includes cutouts 96 configured to accommodate upper frame member 74. Battery 40, shown in phantom in FIG. 6, is housed in battery receiver 42 and a transmission 98, shown in phantom in FIG. 6 and also shown in FIG. 3, is located in interior region 38 formed by upper and lower faux tire sections 44, 52. A forward portion 100 of upper faux tire section 44 and a forward portion 102 of fender 36 underlie seat 34, as suggested in FIGS. 1, 2, 4, and 6.

As suggested in FIG. 6, upper faux tire section 44 includes an outer dimension D₁ having an arc length L₁ of essentially 180° measured between points X and X′ on horizontal plane line P₂, such horizontal plant P₂ being essentially parallel to riding surface 58. Lower faux tire section 52 includes forward and rearward portions 104, 106, respectively, each having an outer dimension D₂ having an arc length L₂ of approximately 33° measured between points X and X′ on a plane P₂, respectively, and points Y and Y′ on diagonal planes P₃ and P₄. As viewed by observer 30, upper and lower faux tire sections 44, 52, including tread 26 and side walls 28, provide a visual appearance of a single large rear tire included on juvenile ride-on vehicle 10, as suggested in FIGS. 1, 4, and 6.

As shown in FIG. 7, juvenile ride-on vehicle 10 includes frame members 74 and 82 coupled to plate 108 located in interior region 38. Plate 108 provides, for example, an anchoring or stabilization for frame members 74, 82 and may also provide stabilization for upper and lower faux tire sections 44, 52. Lower faux tire section 52 is shown coupled to faux tire section supports 54 via fasteners 90 and upper faux tire section 44 is shown coupled to fender 36 via fasteners 94. Battery 40, shown in phantom, is located in battery receiver 42 of upper faux tire section 44.

Left and right faux rear rims 18, 20 include wheel 60, wheel band 62 and wheel cover 64 partially enveloped by portions of faux tire 24, including tread 26 and side walls 28. Openings 48 in bottom portion 84 of lower faux tire section 52 allow wheel bands 62 to contact riding surface 58 as faux rear rims 18, 20 rotate about axis of rotation 22.

Although the present disclosure has been described and illustrated in detail, it is to be clearly understood that this is done by way of illustration and example only and is not to be taken by way of limitation. The scope of the present disclosure is to be limited only by the terms of the appended claims.

1. A juvenile ride-on vehicle comprising
a frame,
a front wheel having an axle mounted to the frame,
first and second faux rear rims mounted to the frame for rotation about an axis of rotation, and
a faux rear wheel including a faux tire mounted in a stationary position on the frame and the first and second faux rear rims, the faux tire including a tread laterally extending between and over a portion of the faux rear rims and having side walls extending from the tread, the side walls being arranged in close proximity to and partially extending over the faux rear rims such that the faux tire provides a visual appearance, to an observer, of a single large rear tire included on the juvenile ride-on vehicle.

2. The juvenile ride-on vehicle of claim 1, wherein the faux tire further includes an upper faux tire section mounted to the frame and a lower faux tire section coupled to the upper faux tire section, the upper and lower faux tire sections cooperating to substantially envelop the faux rear wheels.

3. The juvenile ride-on vehicle of claim 1, wherein the faux tire further includes a pair of faux tire section supports that cooperate to couple an upper and a lower faux tire section of the faux tire to each other, the section supports and the upper and lower faux tire sections cooperating to form an interior region configured to receive portions of the first and second faux rear rims when the upper and lower faux tire sections are coupled together and mounted on the frame.

4. The juvenile ride-on vehicle of claim 1, wherein each faux rear rim includes a rear wheel and a tire mounted on the rear wheel, and wherein the tire is a wheel band.

5. The juvenile ride-on vehicle of claim 4, wherein the lower faux tire section includes a bottom portion having openings therein configured to allow the wheel bands of the faux rear rims to contact a riding surface and rotate about an axis of rotation relative to the faux tire, the faux rear rims being substantially within the interior region.

6. The juvenile ride-on vehicle of claim 2, wherein the upper and lower faux tire sections each include at least one cut-out configured to accommodate at least one frame member, the at least one frame member being coupled to a plate located in an interior region formed by the upper and lower faux tire sections.

7. The juvenile ride-on vehicle of claim 2, wherein the upper faux tire section includes an upper tread section of the tread and a cavity formed therein, the cavity having an upwardly-facing opening configured to receive a battery for mounting therein, the upwardly-facing opening being covered by a fender coupled to the upper faux tire section.

8. The juvenile ride-on vehicle of claim 2, wherein the upper faux tire section includes an outer dimension having a first arc length of essentially 180° measured between points on a horizontal plane, the horizontal plane being essentially parallel to a riding surface, and the lower faux tire section includes forward and rearward portions each having an outer dimension having a second arc length of essentially 33° and each second arc length being measured between a point on the horizontal plane and a point below the horizontal plane located on a diagonal plane having one end directed downwardly toward and intersecting the riding surface.

9. The juvenile ride-on vehicle of claim 7, wherein the fender includes an upper portion extending rearwardly from a seat mounted to the frame and a lower portion extending forwardly and downwardly from the seat, the fender configured to overlie a portion of the upper tread section lying between upper side wall sections of the upper faux tire section.

10. The juvenile ride-on vehicle of claim 7, wherein the cavity includes a bottom portion having openings therethrough, and the upper faux tire section is coupled to the frame via fasteners through the openings.

11. The juvenile ride-on vehicle of claim 2, wherein the upper and lower faux tire sections each include a cut-out configured to receive a portion of the frame.

12. The Juvenile ride-on vehicle of claim 2, wherein the tread includes an upper tread section and a lower tread section, the upper tread section being included on the upper faux tire section and the lower tread section being included on the lower faux tire section, and the upper and lower faux tire sections are coupled together such that the upper and lower tread sections meet at their respective outer circumferences and mate in an essentially seamless fashion.

13. The juvenile ride-on vehicle of claim 3, wherein the upper faux tire section includes an upper side wall section and the lower faux tire section includes a rearward lower side wall section and a forward lower side wall section, the upper side wall section being continuous along an entire outer circumference of an upper tread section of the tread and the forward and rearward lower side wall sections being discontinuous along an outer circumference of a lower tread section of the tread, and the forward and rearward lower side wall sections cooperating to provide an opening therebetween for the faux rear wheels.

14. The juvenile ride-on vehicle of claim 5, wherein each of the section supports is configured to extend in a direction essentially transverse to the axis of rotation and the pair of section supports lie in a plane essentially parallel to each other and parallel to the riding surface when coupled to the upper and lower faux tire sections mounted on the frame.

15. A Juvenile ride-on wheeled vehicle comprising
a frame,
a front wheel having an axle mounted to the frame, and
a faux rear wheel including a faux tire mounted in a stationary position on the frame and two faux rear rims mounted to the frame for rotation about an axis of rotation relative to the stationary faux tire, the faux tire including side walls and a tread interconnecting the side walls and configured to include an interior region for receiving substantial portions of the two faux rear rims therein to allow rotation of the two faux rear rims about the axis of rotation relative to the stationary faux tire and substantially within the interior region, the faux tire providing a visual appearance, to an observer, of a single large rear tire included on the juvenile ride-on vehicle.

16. The juvenile ride-on vehicle of claim 15, wherein the faux tire further includes an upper faux tire section and a lower faux tire section coupled to the upper faux tire section, the upper faux tire section being mounted to the frame and connected to the lower faux tire section by a pair of section supports.

17. The juvenile ride-on vehicle of claim 15, wherein each faux rear rim includes a rear wheel and a tire mounted on the rear wheel, the tire being a wheel band having a treaded surface.

18. The juvenile ride-on vehicle of claim 17, wherein the tread of the faux tire further includes an upper tread section and a lower tread section, the upper tread section being continuous along an outer circumference of the upper tread section and the lower tread section being discontinuous along an outer circumference of the lower tread section, the lower tread section having a rearward lower tread section and a forward lower tread section cooperating to form an opening for the faux rear rims.

19. The juvenile ride-on vehicle of claim 15, wherein the upper faux tire section includes a cavity formed therein, the cavity having an upward-facing opening, the upward-facing opening being covered by a fender coupled to the upper faux tire section, the fender extending rearwardly from a seat mounted to the frame.

20. A juvenile ride-on vehicle comprising
a frame,
a front wheel having an axle mounted to frame, and
a faux rear wheel including a faux tire mounted in a stationary position to the frame and two faux rear rims mounted to the frame for rotation about an axis of rotation relative to the stationary faux tire, the faux tire having an upper faux tire section and a lower faux tire section cooperating to form an interior region to receive and envelop substantial portions of the two faux rear rims, the faux tire providing a visual appearance, to an observer, of a single large rear tire included on the juvenile ride-on vehicle.

21. The juvenile ride-on vehicle of claim 20, wherein the upper faux tire is coupled to the frame and the lower faux tire section is coupled to the upper faux tire section by a section support configured to lie within the interior section and to extend in a direction transverse to the axis of rotation.

22. The juvenile ride-on vehicle of claim 20, wherein each faux rear rim includes a rear wheel having a treaded tire band mounted thereon, the treaded tire band configured
to extend through the lower faux tire section and contact a riding surface.
